(19) United States
(12) Patent Application Publication
(10) Pub. No.: US 2026/0262634 A1
(43) Pub. Date: Sep. 10, 2026

(54) RAINFASTNESS AGENTS

(71) Applicant: Croda International Plc, Goole, East Yorkshire (GB)

(72) Inventors: Katharine Victoria Norman, Goole, East Yorkshire (GB); James Alexander Flavell, Goole, East Yorkshire (GB); Laura Elizabeth Weatherhead, Goole, East Yorkshire (GB); Michael Andrew Oakley, Goole, East Yorkshire (GB)

(73) Assignee: Croda International Plc, Goole, East Yorkshire (GB)

(21) Appl. No.: 19/166,637

(22) PCT Filed: Mar. 20, 2024
(86) PCT No.: PCT/EP2024/057451

§ 371 Date: Sep. 18, 2025

(30) Foreign Application Priority Data
Mar. 21, 2023 (GB) 2304101.5

(51) Int. Cl. A01N 25/24; A01N 25/04; A01N 25/10; A01N 43/54; A01N 51/00; A01P 3/00; A01P 7/04

(52) U.S. Cl. CPC A01N 25/24; A01N 25/04; A01N 25/10; A01N 43/54; A01N 51/00; A01P 3/00; A01P 7/04

(57) ABSTRACT

The present invention relates to rainfastness agents for agrochemical formulations, which comprise alkyd resins and agrochemical actives, nutrients, and/or biostimulants. The alkyd resin is formed from C2 to C16 diacids, C6 to C30 fatty acids, and C3 to C8 polyols. There is also provided a concentrate formulation which may be diluted to give the agrochemical formulation, and a method of treating crops with such formulations, in particular when used in foliar application. The alkyd resin provides for rainfastness properties, whilst also having desired biobased and biodegradable properties, and significantly reduces wash-off for agrochemical actives, nutrients, and biostimulants, after foliar application by spraying.

### CROSS REFERENCE TO RELATED APPLICATIONS

This application is the United States National Phase of PCT International Application No. PCT/EP2024/057451, filed Mar. 20, 2024, which claims priority to Great Britain Patent Application No. 2304101.5, filed Mar. 21, 2023, the disclosures of each of which are hereby incorporated by reference herein in their entireties for all purposes.

### FIELD OF THE INVENTION

The present invention relates to rainfastness agents for agrochemical formulations with agrochemical actives and/or nutrients and/or biostimulants, and a method of providing rainfastness and reduced wash-off of the active or nutrient ingredients by rainfall. The present invention also includes methods of treating crops with such formulations, in particular when used in foliar application.

### BACKGROUND OF THE INVENTION

Biological efficacy of agrochemical actives or nutrients is influenced by a number of factors, one of which is the amount of time the ingredient remains on the treated surface before being washed away by rain, commonly termed rainfastness in the field. Rainfastness may be improved by addition of ingredients in the formulation which can provide resistance to wash-off.

Rainfall can adversely affect a pesticide application by physically washing the active ingredient from the crop to which it is applied or diluting the product to a less effective form. Redistribution of the active ingredient can also happen after rainfall so that the active ingredient may remain less available. Rainfastness is the ability of an active ingredient to remain available on the crop for a longer time when exposed to wet, windy, or rainy conditions. Rainfastness leads to a long lasting activity of the active ingredient(s) under adverse weather conditions such as rain or wind.

Rainfastness can allow a lower dose of active ingredient, nutrient, or biostimulant to be applied with minimal loss of performance and/or allow for longer intervals between spray applications. Application of a low dose of active ingredient and/or with longer spray intervals can also lead to improved crop safety and reduced phytotoxicity. Furthermore, reduced wash-off of active ingredients from crops by rain is also important in reducing unwanted off-target losses of active ingredients to the environment.

A number of previous solutions have been disclosed. For example GB 658,222 discloses the use of vinyl chloride and/or vinylidene chloride polymers and copolymers in aqueous pesticidal compositions for reducing the wash-off of pesticide residues by rainfall. WO 2012/121,413 discloses aqueous pesticidal compositions comprising a pesticidal active ingredient, a carboxy-modified methyl methacrylate-butadiene copolymer, a surfactant and water, having excellent pesticidal activity and being rainfall resistant. WO 2005/115,413 discloses a rain-fast bioactive composition comprising a bioactive ingredient and a suspension concentrate of a latex polymer emulsified with an in-situ crosslinked hydrocarbon polymer. WO 2008/002,623 discloses pesticide formulations with substituted biopolymers and organic polymers for improving residual activity, droplet size, adherence and rainfastness on leaves and reduction in soil leaching. EP0,862,856 discloses pesticide compositions comprising a pesticide and a redispersible polymer. EP2,587,916 discloses compositions for the control of pests, the processes for their preparation and methods of treating (non-plant) surfaces with such formulations for the sustained weather-resistant control of pests. The composition includes a pesticide and an aqueous polymer dispersion comprising a styrene n-butylacrylate t-butylacrylate terpolymer.

Accordingly there is still a need to develop compositions exhibiting good rainfastness and biological efficacy for use in foliar applications with low wash-off, and which also have desired storage-stability. Additionally, there is a desire for said rainfastness agents to be biobased and biodegradable.

There is a need to find rainfastness agents which allow for formation of agrochemical formulations and overcome the above described problems. The present invention also seeks to provide the use of agrochemical concentrates and dilute formulations comprising said rainfastness agents.

### SUMMARY OF THE INVENTION

According to a first aspect of the present invention there is provided an agrochemical formulation comprising;
i) a rainfastness agent selected from an alkyd resin formed from C2 to C16 diacids, C6 to C30 fatty acids, and C3 to C8 polyols; and
ii) at least one selected from an agrochemical active, nutrient, or biostimulant.

According to a second aspect of the present invention there is provided a concentrate formulation suitable for making an agrochemical formulation of the first aspect, said concentrate comprising;
i) a rainfastness agent selected from an alkyd resin formed from C2 to C16 diacids, C6 to C30 fatty acids, and C3 to C8 polyols; and
ii) at least one selected from an agrochemical active, nutrient, or biostimulant dispersed in a water medium.

According to a third aspect, there is provided the use of a rainfastness agent selected from an alkyd resin in accordance with the first aspect as part of a foliar application for improving the rainfastness of an agrochemical active ingredient, nutrient, or biostimulant.

According to a fourth aspect of the present invention there is provided a method of treating vegetation to control pests, the method comprising applying a formulation of the first aspect, and/or a diluted concentrate formulation of the second aspect, either to said vegetation or to the immediate environment of said vegetation.

According to a fifth aspect of the present invention there is provided an emulsified formulation comprising a rainfastness agent selected from an alkyd resin formed from C2 to C16 diacids, C6 to C30 fatty acids, and C3 to C8 polyols, suitable for foliar application.

### DETAILED DESCRIPTION OF THE INVENTION

It has been found that an alkyd resin of the above noted structure provides for desired rainfastness properties when used in a wide range of agrochemical formulations whilst also having desired biobased and biodegradable properties. The alkyd resin has been found to significantly reduce wash-off for agrochemical actives, nutrients, and biostimulants, comprised in an agrochemical formulation after foliar application by spraying.

As used herein, the terms ‘for example,’ ‘for instance,’ ‘such as,’ or ‘including’ are meant to introduce examples that further clarify more general subject matter. Unless otherwise specified, these examples are provided only as an aid for understanding the applications illustrated in the present disclosure, and are not meant to be limiting in any fashion.)

It will be understood that, when describing the number of carbon atoms in a substituent group (e.g. ‘C1 to C6 alkyl’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branched groups.

The agrochemical formulations of the present invention comprise rainfastness agent, said agent being an alkyd resin.

Alkyd resins are polyesters that contain in their structure the functionality of saturated or unsaturated vegetable oils. They are made by esterifying triglycerides (or fatty acids) and various monofunctional and difunctional acids or anhydrides with a variety of di-, tri- and tetra-functional polyols.

Thus, in its simplest form, an alkyd resin may be obtained by reaction of a triglyceride drying oil as defined above with glycerol to give a transesterified intermediate, which is further reacted with a polyfunctional acid to give the alkyd polymer, the chain length of which is determined by the ratio of mono to diglycerides in the mixture or the presence of other monofunctional species such as benzoic acid.

The polyfunctional acid typically used in this reaction is phthalic anhydride and its isomers, but other acids and combinations can also be used. Alkyds can be tailored to meet many end use requirements, either by changing reactants or reactant ratios, or by including modifiers.

Thus, the alkyd resin may be considered a reaction product of polyol, diacid, and fatty acid. The alkyd resin polymers of the present invention are formed from the reaction of C2 to C16 diacids, C6 to C30 fatty acids, and C3 to C8 polyols.

The term polyol is well known in the art, and refers to an alcohol comprising more than one hydroxyl group.

The polyol may be selected from triols, tetrols, pentols, hexols, heptols, or octols. Preferably, the polyol may be selected from triols, tetrols, pentols, hexols, or heptols. More preferably, the polyol may be selected from triols, tetrols, or hexols.

Suitable polyols may be selected from glycerol, diglycerol, triglycerol, tetraglycerol, erythritol, dierythritol, trierythritol, tetraerythritol, propylene glycol, 1,3-propanediol, trimethylolpropane, trimethylolethane, or pentaerythritol. Preferably, said polyol is selected from glycerol, diglycerol, triglycerol, tetraglycerol, trimethylolpropane, trimethylolpropane, isosorbide, or pentaerythritol. More preferably, said polyol is selected from glycerol, diglycerol, triglycerol, dimethylolpropane, trimethylolpropane, or pentaerythritol. Most preferably, glycerol, diglycerol, trimethylolpropane, or pentaerythritol.

In an alternative embodiment, sugar alcohols may be used to form the polyol, although it would be understood than non-sugar alcohols as noted above are preferred. In this specification the terms ‘sugars’ and ‘sugar alcohols’ refer to a group of saccharide derived polyols having from 4 to 7 hydroxyl groups. Examples of preferred sugars and sugar alcohols may include monosaccharides and disaccharides having from 4 to 7 hydroxyl groups.

Preferred sugar alcohols may be selected from glucose, fructose, sorbitol, sorbitan, xylitol, threitol, ribitol, fucitol, mannitol, sucrose, galactitol, iditol, inositol, or volemitol. Monosaccharide sugar alcohols may be particularly preferred. Further preferably, said sugar alcohols may be selected from glucose, fructose or sorbitol. Particularly of sorbitol or sorbitan, may be preferred as polyols obtained from natural sources.

The diacid of the rainfastness agent will be understood to be a molecule containing two carboxylic acid functional groups.

The diacid is selected from a C2 to C16 diacid. Preferably, a C4 to C12 diacid. More preferably, a C4 to C10 diacid.

The diacid may be of any suitable type including both linear, branched, cyclic diacids. In particular, a linear or cyclic diacid may be preferred. A particularly preferred type of diacid is a linear C2 to C16 diacid, more preferably a linear C4 to C10 diacid.

Suitable linear diacids may be selected from oxalic acid, malonic acid, succinic acid, glutaric acid, adipic acid, pimelic acid, suberic acid, azelaic acid, sebacic acid, undecanedioic acid, dodecanedioic acid, brassylic acid, and thapsic acid. Preferably, the diacid may be selected from succinic acid, glutaric acid, adipic acid, pimelic acid, suberic acid, azelaic acid, sebacic acid, and undecanedioic acid. More preferably, selected from succinic acid, adipic acid, azelaic acid, and sebacic acid. Most preferably, sebacic acid.

In an embodiment where cyclic diacids are preferred, suitable diacids may be a dehydrated diacid which results in an anhydride, said anhydride may be substituted or unsubstituted. Suitable anhydrides may be selected from succinic anhydride, and phthalic anhydride.

The fatty acids used in the present invention are C6 to C30 fatty acids. Preferably, selected from C8 to C30 fatty acids, more preferably C12 to C24 fatty acids, particularly C14 to C22 fatty acids, further preferably C16 to C22 fatty acids. Especially, C18 fatty acids may be preferred.

The fatty acids may be selected from linear or branched fatty acids. The fatty acids may be selected from saturated or unsaturated fatty acids.

Where unsaturated fatty acids are present, these may be selected from unsaturated fatty acids comprising at least one unsaturated carbon-carbon double bond. Particularly preferred are unsaturated fatty acids having in the range from 1 to 3 carbon-carbon double bonds. Most preferred are mono-unsaturated or di-unsaturated fatty acids residues. The carbon-carbon double bond(s) of the fatty chain may be present either in a cis or a trans configuration.

Preferably, the fatty acids residues used are derived from linear mono-unsaturated or di-unsaturated fatty acids. The preferred fatty acids may also comprise some tri-unsaturated fatty acids as it has been found that addition may improve cold liquid stability properties.

Iodine values are understood to represent the average amount of unsaturation of fats or oils, and is expressed in terms of the number of centigrams of iodine absorbed per gram of sample (% iodine absorbed). Where unsaturated fatty acids are present, said fatty acids may be selected such that the iodine value is greater than 70. Preferably, said iodine value is greater than 90. More preferably, said iodine value is greater than 100. Most preferably, said iodine value is greater than 110.

Suitable saturated fatty acids may be selected from caprylic acid, capric acid, lauric acid, myristic acid, palmitic acid, stearic acid, isostearic acid, arachidic acid, behenic acid, or lignoceric acid. Preferred saturated fatty acids may be selected from caprylic acid, capric acid, stearic acid, isostearic acid, or lauric acid.

Suitable unsaturated fatty acids may be selected from myristoleic acid, palmitoleic acid, sapienic acid, oleic acid, elaidic acid, vaccenic acid, linoleic acid, linoelaidic acid, arachidonic acid, eicosapentaenoic acid, erucic acid, or docosahexaenoic acid. Preferred unsaturated fatty acids may be selected from oleic acid, linoleic acid, linolenic acid, palmitoleic acid, or elaidic acid. Particularly preferred unsaturated fatty acids may be oleic acid, linoleic acid, and mixtures thereof.

In particular, most preferred fatty acids may be selected from isostearic (saturated, branched C18), stearic (saturated linear C18), isostearic (saturate branched C18), caprylic (saturated linear C8), lauric (saturated linear C12), and mixtures thereof.

The fatty acids may be unsaturated fatty acid mixtures obtained from natural fats and oils, e.g. canola oil, sunflower oil, soybean oil, olive oil, cotton seed oil, grape seed oil, peanut oil, rapeseed oil, safflower oil, cottonseed oil, or tall oil. Preferably canola oil, rapeseed oil, safflower oil, soybean oil, or tall oil. More preferably, soybean oil or rapeseed oil.

Particularly preferred fatty acids may be selected from soybean oil, stearic acid, or isostearic acid.

In an alternative embodiment, the fatty acid used may be purified prior to use in the present invention. Purification may be undertaken to raise the levels of desired fatty acid chains and reduce the level of undesired fatty acid chains in order to modify the iodine values, titre values, or pour points.

The fatty acid can be a mixture which is either formed by blending a number of different fatty acids, or a mixture that naturally occurs as a result of using a natural oil.

Specific alkyd resins formed from combinations of polyols, diacids, and fatty acids may be preferred. The preferred combinations may be selected from: glycerol-azelaic acid-rapeseed oil, glycerol-isostearic acid-adipic acid, glycerol-succinic acid-soybean oil, pentaerythritol-azelaic acid-soybean oil, trimethylolpropane-adipic acid-soybean oil, glycerol-adipic acid-isostearic acid, glycerol-azelaic acid-stearic/isostearic acid blend, diglycerol-azelaic acid-stearic/isostearic acid blend, diglycerol-sebacic acid-soybean oil, pentaerythritol-sebacic acid-soybean oil, glycerol-adipic acid-lauric acid, pentaerythritol-succinic anhydride-soybean oil, glycerol-adipic acid-adipic acid-stearic acid, pentaerythritol-adipic acid-caprylic acid, and glycerol-azelaic acid-soybean oil and stearic acid blend.

The alkyd resin formed may be of any suitable type including both linear and branched copolymers. Where the copolymer is linear, it may be a block, alternating, or periodic copolymer. Where the copolymer is branched, it may be a graft or star copolymer. In particular, a branched copolymer may be preferred.

The molecular weight of the alkyd resin is typically from 2,000 to 280,000 Da, particularly from 2,500 to 250,000 Da, more particularly from 3,000 to 220,000 Da, and especially about 3,500 to 210,000 Da.

In a particular embodiment, the molecular weight may be in the range from 92,000 to 220,000 Da, particularly from 100,000 Da to 180,000 Da, more particularly from 115,000 to 165,000 Da, and especially about 125,000 to 150,000 Da.

The molecular weight will be determined by size exclusion chromatography such as size-exclusion GPC (SE-GPC) as described herein, specifically the TSKgel GMPWXL Protocol.

The amount of C3 to C8 polyols present in the alkyd resin is in the range from 5 to 45 wt. % as a percentage of the total copolymer weight. More preferably, in the range of 7 to 40 wt. %. Further preferably, in the range of 10 to 38 wt. %. Most preferably, in the range of 15 to 35 wt. %.

The amount of C2 to C16 diacid present in the alkyd resin is in the range from 2 to 60 wt. % as a percentage of the total copolymer weight. More preferably, in the range of 5 to 55 wt. %. Further preferably, in the range of 8 to 50 wt. %. Most preferably, in the range of 10 to 45 wt. %.

The amount of C6 to C30 fatty acids present in the alkyd resin is in the range from 20 to 85 wt. % as a percentage of the total copolymer weight. More preferably, in the range of 25 to 80 wt. %. Further preferably, in the range of 30 to 75 wt. %. Most preferably, in the range of 35 to 70 wt. %.

The molar ratio of the fatty acid to polyol to diacid may be in the range 1:0.35-0.60:0.60-0.95. Preferably, in the range from 1:0.40-0.57:0.70-0.95. More preferably, in the range from 1:0.45-0.53:0.75-0.94.

The alkyd resin may be used in an emulsified form or an emulsification system, that can be combined with an agrochemical formulation.

Preferably the carbon-containing parts of the alkyd resin are at least 60% biobased on the basis of the total weight of the carbon-containing parts of the composition, more preferably at least 70%, particularly at least 80% biobased.

The level of biobased content of the compound may be determinable by the standardised analytical method ASTM D6866 using ¹⁴C radiocarbon dating. ASTM D6866 distinguishes carbon resulting from bio-based inputs from those derived from fossil-based inputs. Using this standard, a percentage of carbon from renewable sources can be calculated from the total carbon in the sample.

The alkyd resin may be biodegradable. Preferably, at least 25% of the alkyd resin degrades within a 28 day period in accordance with the OECD methods 301B and 301F. More preferably, at least 30%. Most preferably, at least 40%.

The alkyd resin may therefore have the advantage from prior compounds used for this function in being more biobased, more biodegradable, and therefore more sustainable.

The alkyd resin may be made by any known method, and well within the knowledge of the skilled person in the field.

For example, the alkyd resin may be formed using the fatty acid process in a dicaid, a polyol, and a fatty acid are combined and heated together until the product has achieved a predetermined level of viscosity.

The formulation/composition may comprise one or more biologically active ingredients (including plant enhancing agents, in particular plant protective products (also referred to as PPPs)). Suitable examples of active ingredients, in particular plant enhancing agents, are fungicidal agents, bactericidal agents, insecticidal agents, nematicidal agents, molluscicidal agents, biologicals, acaricides or miticides, pesticides, and biocides.

Further possible active ingredients include disinfectants, microorganisms, rodent killers, weed killers (herbicides), attracting agents, (bird) repellent agents, plant growth regulators (such as gibberellic acid, auxin or cytokinin), nutrients (such as potassium nitrate, magnesium sulphate, iron chelate), plant hormones, minerals, plant extracts, germination stimulants, pheromones, biological preparations, etc.

Suitable agrochemical actives for use in the formulations according to the invention are all agrochemically active compounds that may be solid or liquid at room temperature. It is envisaged that the adjuvant of the present invention would have broad applicability to all types of agrochemical actives.

Agrochemical actives refer to biocides which, in the context of the present invention, are plant protection agents, more particular chemical substances capable of killing different forms of living organisms used in fields such as medicine, agriculture, forestry, and mosquito control. Also counted under the group of biocides are so-called plant growth regulators.

Biocides for use in agrochemical formulations of the present invention are typically divided into two sub-groups:
pesticides, including fungicides, herbicides, insecticides, algicides, moluscicides, miticides and rodenticides, and
antimicrobials, including germicides, antibiotics, antibacterials, antivirals, antifungals, antiprotozoals and antiparasites.

In particular, biocides selected from insecticides, fungicides, or herbicides may be particularly preferred.

The term ‘pesticide’ will be understood to refer to any substance or mixture of substances intended for preventing, destroying, repelling, or mitigating any pest. A pesticide may be a chemical substance or biological agent (such as a virus or bacteria) used against pests including insects, plant pathogens, weeds, mollusks, birds, mammals, fish, nematodes (roundworms) and microbes that compete with humans for food, destroy property, spread disease or are a nuisance. In the following examples, pesticides suitable for the agrochemical compositions according to the present invention are given.

A fungicide is a chemical control of fungi. Fungicides are chemical compounds used to prevent the spread of fungi in gardens and crops. Fungicides are also used to fight fungal infections. Fungicides can either be contact or systemic. A contact fungicide kills fungi when it comes into contact with the fungicide retained on leaf surfaces. A systemic fungicide is absorbed into plant tissues and kills the fungus when it attempts to invade the host.

Examples for suitable fungicides, according to the present invention, encompass the following species: (3-ethoxypropyl) mercury bromide, 2-methoxyethylmercury chloride, 2-phenylphenol, 8-hydroxyquinoline sulphate, 8-phenylmercuri oxyquinoline, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulphide, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, blasticidin-S, Bordeaux mixture, boscalid, bridged diphenyl fungicides, bromuconazole, bupirimate, Burgundy mixture, buthiobate, butylamine, calcium polysulphide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper (II) acetate, copper (II) carbonate, basic, copper fungicides, copper hydroxide, copper naphthenate, copper oleate, copper oxychloride, copper (II) sulphate, copper sulphate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dicarboximide fungicides, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, dinitrophenol fungicides, dinobuton, dinocap, dinocton, dinopenton, dinosulphon, dinoterbon, diphenylamine, dipyrithione, disulphiram, ditalimfos, dithianon, dithiocarbamate fungicides, DNOC, dodemorph, dodicin, dodine, donatodine, drazoxolon, edifenphos, epoxiconazole, etaconazole,etem, ethaboxam, ethirimol, ethoxyquin, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulph, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fludioxonil, flumetover, fluopicolide, fluoroimide, fluotrimazole, fluoxastrobin, fluquinconazole, flusilazole, flusulphamide, flutolanil, flutriafol, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isoprothiolane, isovaledione, kasugamycin, kresoxim-methyl, lime sulphur, mancopper, mancozeb, maneb, mebenil, mecarbinzid, mepanipyrim, mepronil, mercuric chloride, mercuric oxide, mercurous chloride, mercury fungicides, metalaxyl, metalaxyl-M, metam, metazoxolon, metconazole, methasulphocarb, methfuroxam, methyl bromide, methyl isothiocyanate, methylmercury benzoate, methylmercury dicyandiamide, methylmercury pentachlorophenoxide, metiram, metominostrobin, metrafenone, metsulphovax, milneb, morpholine fungicides, myclobutanil, myclozolin, N-(ethylmercury)-p-toluenesulphonanilide, nabam, natamycin, nitrostyrene, nitrothal-isopropyl, nuarimol, OCH, octhilinone, ofurace, organomercury fungicides, organophosphorus fungicides, organotin fungicides, orysastrobin, oxadixyl, oxathiin fungicides, oxazole fungicides, oxine copper, oxpoconazole, oxycarboxin, pefurazoate, penconazole, pency curon, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulphamide fungicides, phosdiphen, phthalide, phthalimide fungicides, picoxystrobin, piperalin, polycarbamate, polymeric dithiocarbamate fungicides, polyoxins, polyoxorim, polysulphide fungicides, potassium azide, potassium polysulphide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfiir, pyrrole fungicides, quinacetol, quinazamid, quinconazole, quinoline fungicides, quinone fungicides, quinoxaline fungicides, quinoxyfen, quintozene, rabenzazole, salicylanilide, silthiofam, simeconazole, sodium azide, sodium orthophenylphenoxide, sodium pentachlorophenoxide, sodium polysulphide, spiroxamine, streptomycin, strobilurin fungicides, sulphonanilide fungicides, sulphur, sultropen, TCMTB, tebuconazole, tecloftalam, tecnazene, tecoram, tetraconazole, thiabendazole, thiadifluor, thiazole fungicides, thicyofen, thifluzamide, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, trifloxystrobin, triflumizole, triforine, triticonazole, unclassified fungicides, undecylenic acid, uniconazole, urea fungicides, validamycin, valinamide fungicides, vinclozolin, zarilamid, zinc naphthenate, zineb, ziram, zoxamide, and mixtures thereof.

A herbicide is a pesticide used to kill unwanted plants. Selective herbicides kill specific targets while leaving the desired crop relatively unharmed. Some of these act by interfering with the growth of the weed and are often based on plant hormones. Herbicides used to clear waste ground are non-selective and kill all plant material with which they come into contact. Herbicides are widely used in agriculture and in landscape turf management. They are applied in total vegetation control (TVC) programs for maintenance of highways and railroads. Smaller quantities are used in forestry, pasture systems, and management of areas set aside as wildlife habitat.

Examples of herbicides that can be employed in the present disclosure include, but are not limited to: 4-CPA, 4-CPB, 4-CPP, 2,4-D, 3,4-DA, 2,4-DB, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofiuor, benzoylprop, benzthiazuron, bicyclopyrone, bifenox, bilanafos, bispyribac, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chiorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, cinidon-ethyl, cinmethylin, cinosulfuron, cisanilide, clethodim, cliodinate, clodinafop, clofop, clomazone, clomeprop, cloprop, cloproxydim, clopyralid, cloransulam, CMA, copper sulfate, CPMF, CPPC, credazine, cresol, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, diallate, dicamba, dichlobenil, dichloralurea, dichloiTnate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P, fenoxasulfone, fenteracol, fenthiaprop, fentrazamide, fenuron, ferrous sulfate, flamprop, flamprop-M, flazasulfuron, florasulam, fluazifop, fluazifop-P, fluazolate, flucarbazone, flucetosulfuron, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, fluorochloridone, fluoroxypyr, flurtamone, fluthiacet, fomesafen, foramsulfuron, fosamine, furyloxyfen, glufosinate, glufosinate-P, glyphosate, halosafen, halosulfuron, haloxydine, haloxyfop, haloxyfop-P, hexachloroacetone, hexaflurate, hexazinone, imazamethabenz, imazamox, imazapic, imazapyr, imazaquin, imazethapyr, imazosulfuron, indanofan, indazifiam, iodobonil, iodomethane, iodosulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, linuron, MAA, MAMA, MCPA, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, orthodichlorobenzene, orthosulfamuron, oryzalin, oxadiargyl, oxadiazon, oxapyrazon, oxasulfuron, oxaziclomefone, oxyfluorfen, parafluoron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron, procyazine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluoron, thenylchlor, thiazafluoron, thiazopyr, thidiazimin, thi diazuron, thiencarbazone-methyl, thifensulfuron, thiobencarb, tiocarbazil, tioclorim, topramezone, tralkoxydim, tri-allate, triasulfuron, triaziflam, tribenuron, tricamba, triclopyr, tridiphane, trietazine, trifloxysulfuron, trifluralin, triflusulfuron, trifop, trifopsime, trihydroxytriazine, trimeturon, tripropindan, tritac tritosulfuron, vemolate, xylachlor and mixtures thereof. Safeners mean active ingredients applied with herbicides to protect crops against their injury. Some of the safeners that can be employed in the present disclosure include, but are not limited to: benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148, N-phenylsulfonylbenzoic acid amides and mixtures thereof.

Suitable herbicides may be selected from the group comprising: aryloxycarboxylic acid e.g. MCPA, aryloxyphenoxypropionates e.g. clodinafop, cyclohexanedione oximes e.g. sethoxydim, hydroxybenzonitriles e.g. bromoxynil, sulphonylureas e.g. nicosulphuron, triazolopyrimidines e.g. penoxsulam, triketiones e.g. mesotriones, triazine herbicides such as metribuzin, hexaxinone, or atrazine; sulphonylurea herbicides such as chlorsulfuron; uracils, bromacil, or terbacil; urea herbicides such as linuron, diuron, siduron, or neburon; acetanilide herbicides such as alachlor, or metolachlor; thiocarbamate herbicides such as benthiocarb, triallate; oxadiazolone herbicides such as oxadiazon; isoxazolidone herbicides, phenoxyacetic acids; diphenyl ether herbicides such as fluazifop, acifluorfen, bifenox, or oxyfluorfen; dinitro aniline herbicides such as trifluralin; organophosphonate herbicides such as glufosinate salts and esters and glyphosate salts and esters; and/or dihalobenzonitrile herbicides such as bromoxynil, or ioxynil, benzoic acid herbicides, dipyridilium herbicides such as paraquat; and other herbicides such as clomazone, carfentrazone, saflufenacil, and pyroxasulphone.

An insecticide is a pesticide used against insects in all developmental forms, and include ovicides and larvicides used against the eggs and larvae of insects. Insecticides are used in agriculture, medicine, industry, and the household.

Examples of insecticides that can be employed in the present disclosure include, but are not limited to: 1,2-dichloropropane, abamectin, acephate, acetamiprid, acethion, acetoprole, acrinathrin, acrylonitrile, alanycarb, aldicarb, aldoxycarb, aldrin, allethrin, allosamidin, allyxycarb, alpha-cypermethrin, alpha-ecdysone, alpha-endosulfan, amidithion, aminocarb, amiton, amiton oxalate, amitraz, anabasine, athidathion, azadirachtin, azamethiphos, azinphos-ethyl, azinphos-methyl, azothoate, barium hexafluorosilicate, barthrin, bendiocarb, benfuracarb, bensultap, beta-cyfluthrin, beta-cypermethrin, bifenthrin, bioallethrin, bioethanomethrin, biopermethrin, bistrifluoron, borax, boric acid, bromfenvinfos, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, cartap hydrochloride, chlorantraniliprole, chlorbicyclen, chlordane, chlordecone, chlordimeform, chlordimeform hydrochloride, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, chiOmafenozide, cinerin I, cinerin II, cinerins, cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyantraniliprole, cyclethrin, cycloprothrin, cyfluthrin, cyhalothrin, cypermethrin, cyphenothrin, cyromazine, cythioate, DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diatomaceous earth, diazinon, dicapthon, dichlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinex-diclexine, dinoprop, dinosam, dinotefuran, diofenolan, dioxabenzofos, dioxacarb, dioxathion, disulfoton, dithicrofos, d-limonene, DNOC, DNOC-ammonium, DNOC-potassium, DNOC-sodium, doramectin, ecdysterone, emamectin, emamectin benzoate, EMPC, empenfhrin, endosulfan, endothion, endrin, EPN, epofenonane, eprinomectin, esdepallethrine, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flonicamid, flubendiamide, flucofuron, flucycloxuron, flucythrinate, flufenerim, flufenoxuron, flufenprox, fluvalinate, fonofos, formetanate, formetanate hydrochloride, formothion, fomiparanate, fomiparanate hydrochloride, fosmethilan, fospirate, fosthietan, fufenozide, furathiocarb, furethrin, gamma-cyhalothrin, gamma-HCH, halfenprox, halofenozide, HCH, HEOD, heptachlor, heptenophos, heterophos, hexaflumuron, HHDN, hydramethylnon, hydrogen cyanide, hydroprene, hyquincarb, imidacloprid, imiprothrin, indoxacarb, iodomethane, IPSP, isazofos, isobenzan, isocarbophos, isodrin, isofenphos, isofenphosmethyl, isoprocarb, isoprothiolane, isothioate, isoxathion, ivermectin, jasmolin I, jasmolin II, jodfenphos, juvenile hormone I, juvenile hormone II, juvenile hormone III, kelevan, kinoprene, lambda-cyhalothrin, lead arsenate, lepimectin, leptophos, lindane, lirimfos, lufenuron, lythidathion, malathion, malonoben, mazidox, mecarbam, mecarphon, menazon, meperfluthrin, mephosfolan, mercurous chloride, mesulfenfos, metaflumizone, methacrifos, methamidophos, methidathion, methiocarb, methocrotophos, methomyl, methothrin, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, molosultap, monocrotophos, monomehypo, monosultap, morphothion, moxidectin, naftalofos, naled, naphthalene, nicotine, nifluridide, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluoron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, profenofos, profluralin, profluthrin, promacyl, promecarb, propaphos, propetamphos, propoxur, prothidathion, prothiofos, prothoate, protrifenbute, pymetrozine, pyraclofos, pyrafluprole, pyrazophos, pyresmethrin, pyrethrin I, pyrethrin II, pyrethrins, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, silica gel, sodium arsenite, sodium fluoride, sodium hexafluorosilicate, sodium thiocyanate, sophamide, spinetoram, spiromesifen, spirotetramat, sulcofuron, sulcofuron-sodium, sulfluramid, sulfotep, sulfoxaflor, sulfuryl fluoride, sulprofos, tau-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, tetramethylfluthrin, theta-cypei-methiin, thiacloprid, thiamethoxam, thicrofos, thiocarboxime, thiocyclam, thiocyclam oxalate, thiodicarb, thiofanox, thiometon, thiosultap, thiosultap-disodium, thiosultap-monosodium, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin, zolaprofos and mixtures thereof.

Miticides are pesticides that kill mites. Antibiotic miticides, carbamate miticides, formamidine miticides, mite growth regulators, organochlorine, permethrin and organophosphate miticides all belong to this category. Molluscicides are pesticides used to control mollusks, such slugs and snails. These substances include metaldehyde, methiocarb and aluminium sulphate. A nematicide is a type of chemical pesticide used to kill parasitic nematodes (a phylum of worm).

Biologicals, which will be understood as products derived from living organisms such as bacteria or fungi, may also be used.

Most preferably, the active present in the agrochemical formulation of the present invention may be selected from carbamate, carboxamide, chloronitile, copper compounds, strobilurin, triazole, phosphoramidate, cyanoimidamide, nitroguanidine, organophosphate, pyrethroid, chloroacetamide, phenyl ether, sulfonylurea, and triazine.

The formulation may comprise at least one nutrient. Nutrients refer to chemical elements and compounds which are desired or necessary to promote or improve plant growth. Nutrients generally are described as macronutrients or micronutrients. Suitable nutrients for use in the concentrates according to the invention are micronutrient compounds, preferably those which are solid at room temperature or are partially soluble.

Nutrients may be present in addition to, or as an alternative to, agrochemical actives. In such formulations/compositions the nutrient is typically in a dry form.

The nutrients may preferably be a solid phase nutrients. Solid nutrients are to be understood in the present invention as meaning substances whose melting point is above 20° C. (at standard pressure). Solid nutrients will also include insoluble nutrient ingredients, i.e. nutrient ingredients whose solubility in water is such that a significant solid content exists in the concentrate after addition.

Micronutrients typically refer to trace metals or trace elements, and are often applied in lower doses. Suitable micronutrients include trace elements selected from zinc, boron, chlorine, copper, iron, molybdenum, and manganese. It is envisaged that the rainfastness agent of the present invention would have broad applicability to all types of micronutrients.

The micronutrients may be in a soluble form or included as insoluble solids, and may be in the form of salts or chelates. Preferably, the micronutrient is in the form of a carbonate or oxide.

Preferably, the micronutrient may be selected from zinc, calcium, molybdenum or manganese, or magnesium. Particularly preferred micronutrients for use with the present invention may be selected from zinc oxide, manganese carbonate, manganese oxide, or calcium carbonate.

The amount of micronutrient in the concentrate, if present, may typically be in the range from 5 wt. % to 40 wt. %, more usually, 10 wt. % to 35 wt. %, particularly 15 wt. % to 30 wt. %, by weight based on the total concentrate.

Typically, as mixed into formulations during make up the average particle size of solid agrochemicals is from 50 μm to 100 μm, but formulations are typically wet milled after mixing to reduce the average particle size to from 1 μm to 10 μm, more preferably from 1 μm to 5 μm.

The formulations of the present invention may also comprise at least one macronutrient. Macronutrients typically refer to those comprising nitrogen, phosphorus, and potassium, and include fertilisers such as ammonium sulphate, and water conditioning agents. Suitable macronutrients include fertilisers and other nitrogen, phosphorus, or sulphur containing compounds, and water conditioning agents.

Suitable fertilisers include inorganic fertilisers that provide nutrients such as nitrogen, phosphorus, potassium or sulphur. Examples of such fertilisers include:
for nitrogen as the nutrient: nitrates and or ammonium salts such as ammonium nitrate, including in combination with urea e.g. as uran type materials, calcium ammonium nitrate, ammonium sulphate nitrate, ammonium phosphates, particularly mono-ammonium phosphate, di-ammonium phosphate and ammonium polyphosphate, ammonium sulphate, and the less commonly used calcium nitrate, sodium nitrate, potassium nitrate and ammonium chloride;
for phosphorus as the nutrient: acidic forms of phosphorus such as phosphoric, pyrophosphoric or polyphosphoric acids, but more usually salt forms such as ammonium phosphates, particularly mono-ammonium phosphate, di-ammonium phosphate, and ammonium polyphosphate, potassium phosphates, particularly potassium dihydrogen phosphate and potassium polyphosphate;
for sulphur as the nutrient: ammonium sulphate and potassium sulphate, e.g. the mixed sulphate with magnesium.

Biostimulants may enhance metabolic or physiological processes such as respiration, photosynthesis, nucleic acid uptake, ion uptake, nutrient delivery, or a combination thereof. Non-limiting examples of biostimulants include seaweed extracts, humic acids (e.g., potassium humate), fulvic acids, myoinositol, glycine, jasmonic acid, benzoic acid, diphenyl urea, and combinations thereof.

Agrochemically active compounds, including insecticides, herbicides, and fungicides, require a formulation which allows the active compounds to be taken up by the plant/the target organisms or remain on the target surface.

The term ‘agrochemical formulation’ as used herein refers to compositions including an active agrochemical, and is intended to include all forms of compositions, including concentrates and spray formulations. If not specifically stated, the agrochemical formulation of the present invention may be in the form of a concentrate, a diluted concentrate, or a sprayable formulation.

The rainfastness agent of the present invention may be combined with other components in order to form an agrochemical formulation comprising at least one agrochemical active and/or nutrient and/or biostimulant.

Agrochemical concentrates are agrochemical compositions, which may be aqueous or non-aqueous, and which are designed to be diluted with water (or a water-based liquid) to form the corresponding spray formulations. Said compositions include those in liquid form (such as solutions, emulsions, or dispersions) and in solid form (especially in water dispersible solid form) such as granules or powders.

Accordingly, agrochemical active compounds may be formulated as an emulsifiable concentrate (EC), emulsion in water (EW), suspension concentrate (SC), soluble liquid (SL), as an oil-based suspension concentrate (OD), microemulsions (ME), and/or suspoemulsions (SE).

It is envisaged that the rainfastness agent of the present invention will particularly find use in water based systems, like SC formulations.

The alkyd resin emulsion may be used as a built-in component, or may be used as a tank mix.

The aqueous agrochemical concentrates are agrochemical compositions designed to be diluted with water (or a water based liquid) to form the corresponding spray formulations.

Spray formulations are aqueous agrochemical formulations including all the components which it is desired to apply to the plants or their environment. Spray formulations can be made up by simple dilution of concentrates containing desired components (other than water).

The rainfastness agent may therefore be incorporated into the formulation of the agrochemical active compound (in-can/built-in formulation).

According to the needs of the customer, concentrates thus formed may comprise typically up to 95 wt. % agrochemical actives. Said concentrates may be diluted for use resulting in a dilute composition having an agrochemical active concentration of about 0.5 wt. % to about 1 wt. %. In said dilute composition (for example, a spray formulation, where a spray application rate may be from 10 to 500 1.ha-1) the agrochemical active concentration may be in the range from about 0.001 wt. % to about 1 wt. % of the total formulation as sprayed.

In agrochemical formulation concentrates, the proportion of the rainfastness agent will depend on the solubility of the components in the liquid carrier. Typically, the concentration of the rainfastness agent in such a concentrate will be from 1 wt. % to 20 wt. %. Preferably, from 1.5 wt. % to 13 wt. %. More preferably, from 2 wt. % to 10 wt. %.

The weight ratio of rainfastness agent to active agrochemical in the concentrate and dilute concentrate agrochemical formulation is preferably from about 0.05:1 to about 0.2:1. More preferably, from about 0.7:1 to about 0.15:1. This ratio range will generally be maintained for concentrate forms of formulations, and in the spray formulations.

When concentrates (solid or liquid) are used as the source of active agrochemical and/or rainfastness agent, the concentrates will typically be diluted to form the spray formulations. The dilution may be with from 1 to 10,000, particularly 10 to 1,000, times the total weight of the concentrate of water to form the spray formulation.

Where the agrochemical active is present in the aqueous end use formulation as solid particles, most usually it will be present as particles mainly of active agrochemical. However, if desired, the active agrochemical can be supported on a solid carrier e.g. silica or diatomaceous earth, which can be solid support, filler or diluent material as mentioned above.

The spray formulations will typically have a pH within the range from moderately acidic (e.g. about 3) to moderately alkaline (e.g. about 10), and particular near neutral (e.g. about 5 to 8). More concentrated formulations will have similar degrees of acidity/alkalinity, but as they may be largely non-aqueous, pH is not necessarily an appropriate measure of this.

The formulation may also comprise additional components such as pigments, dyes, bulking agents, and combinations thereof.

The agrochemical formulation may also include other components as desired. These other components may be selected from those including:
further binders, particularly binders which are readily water soluble to give low viscosity solutions at high binder concentrations, such as polyvinylpyrrolidone; polyvinyl alcohol; carboxymethyl cellulose; gum arabic; sugars e.g. sucrose or sorbitol; starch; ethylene-vinyl acetate copolymers, sucrose and alginates,
solvents (other than water) such as monopropylene glycol, or oils which can be vegetable or mineral oils such as spray oils (oils included in spray formulations as non-surfactant adjuvants. Such solvents may be included as a solvent for the rainfastness agent, and/or as a humectant, e.g. especially propylene glycol. When used such solvents will typically be included in an amount of from 5 wt. % to 500 wt. %, desirably 10 wt. % to 100 wt. %, by weight of the rainfastness agent.
diluents, absorbents or carriers such as carbon black; talc; diatomaceous earth; kaolin; aluminium, calcium or magnesium stearate; sodium tripolyphosphate; sodium tetraborate; sodium sulphate; sodium, aluminium and mixed sodium-aluminium silicates; and sodium benzoate,
disintegration agents, such as surfactants, materials that swell in water, for example carboxy methylcellulose, collodion, polyvinylpyrrolidone and microcrystalline cellulose swelling agents; salts such as sodium or potassium acetate, sodium carbonate, bicarbonate or sesquicarbonate, ammonium sulphate and dipotassium hydrogen phosphate;
wetting agents such as alcohol ethoxylate and alcohol ethoxylate/propoxylate wetting agents;
dispersants such as sulphonated naphthalene formaldehyde condensates and acrylic copolymers such as the comb copolymer having capped polyethylene glycol side chains on a polyacrylic backbone;
emulsifiers such as alcohol ethoxylates, ABA block co polymers, or castor oil ethoxylates;
antifoam agents, e.g. polysiloxane antifoam agents, typically in amounts of 0.005 wt. % to 10 wt. % of the formulation;
viscosity modifiers such as commercially available water soluble or miscible gums, e.g. xanthan gums, and/or cellulosics, e.g. carboxy-methyl, ethyl or propylcellulose; and/or
preservatives and/or anti-microbials such as organic acids, or their esters or salts such as ascorbic e.g. ascorbyl palmitate, sorbic e.g. potassium sorbate, benzoic e.g. benzoic acid and methyl and propyl 4-hydroxybenzoate, propionic e.g. sodium propionate, phenol e.g. sodium 2-phenylphenate; 1,2-benzisothiazolin-3-one; or formaldehyde as such or as paraformaldehyde; or inorganic materials such as sulphurous acid and its salts, typically in amounts of 0.01 wt. % to 1 wt. % of the formulation.

The agrochemical formulation according to the present invention may also contain components, such as surfactant materials which form part of the emulsifier system. Said surfactants may include surfactant dispersants.

Adjuvants may be included in the compositions and formulations of and used in this invention.

The invention further includes a method of treating plants using formulations of the first aspect.

Accordingly the invention further includes methods of use including:
a method of killing or inhibiting vegetation by applying to the vegetation, or the immediate environment of the vegetation e.g. the soil around the vegetation, a spray formulation including at least one alkyd resin of the first aspect; and/or
a method of killing or inhibiting pests of plants by applying to the plants or the immediate environment of the plants e.g. the soil around the plants, a spray formulations including at least agrochemical active which is one or more pesticides, for example insecticides, fungicides or acaricides, and the alkyd resin of the first aspect.

As used herein, the term ‘rainfastness’ refers to the degree to which agrochemical actives and/or nutrients may remain on a treated surface (such as a leaf) after rainfall or irrigation. Therefore, with regard to the present invention rainfastness is thus defined as the percentage of active ingredient, nutrient, and/or biostimulant that remains on the crop after rainfall or irrigation. The absolute degree of rainfastness of pesticides is highly variable and depends on the physico-chemical properties of the active ingredient and/or nutrient.

Preferably, the rainfastness agent of the present invention may find use as either the sole component or principal rainfastness functioning agent when formulated directly into agrochemical formulations.

The rainfastness agents of the present invention, may provide for a reduction in wash-off when compared to a formulation not comprising the alkyd resin of more than 20%, preferably more than 40%, most preferably more than 50%.

The rainfastness, values and changes are measured by techniques and methods as described in further detail herein.

It will be appreciated that the dispersion in the agrochemical formulation comprises particles of low water solubility solids and therefore the particle size and distribution is a factor which reflects the stability of the dispersion. It is important that there is a homogeneous distribution of the particles to ensure stability of the dispersion for a longer period. It is important that any components added do no lead to particles coming together or cause phase separation. Therefore, a dispersion with stable particle size, homogeneous particle distribution, and limited particle size growth over time, is likely to be a more stable dispersion.

In the form of a distribution of particle sizes, the particles would have a median volume particle diameter value. It will be understood that the median volume particle diameter refers to the equivalent spherical diameter corresponding to the point on the distribution which divides the population exactly into two equal halves. It is the point which corresponds to 50% of the volume of all the particles, read on the cumulative distribution curve relating volume percentage to the diameter of the particles i.e. 50% of the distribution is above this value and 50% is below. This value is referred to as the “D(v,0.5)” value and is determined as described herein. Additionally, “D(v,0.9)” values can also be referred to, and these values would be the equivalent spherical diameter corresponding to 90% of the volume of all the particles, read on the cumulative distribution curve relating volume percentage to the diameter of the particles, i.e. they are the points where 10% of the distribution is above this value and 90% are below the value respectively.

The particle size values, used to determine the D(v,0.9) values, are measured by techniques and methods as described in further detail herein.

It is generally known that particle sizes of 200-18,000 nm is preferred in order to obtain a stable dispersion having the desired properties.

The particles present in the emulsion of the present invention may have a D(v,0.9) value in the range from 100 nm to 4,000 nm. Preferably, in the range from 150 nm to 3,500 nm. More preferably, in the range from 200 nm to 3,000 nm.

The particles present in active ingredient dispersion formulation of the present invention may have a D(v,0.9) value in the range from 0.5 μm to 40 μm. Preferably, in the range from 0.5 μm to 20 μm. More preferably, in the range from 1 μm to 5 μm.

All of the features described herein may be combined with any of the above aspects, in any combination.

### Examples

In order that the present invention may be more readily understood, reference will now be made, by way of example, to the following description.

It will be understood that all tests and physical properties listed have been determined at atmospheric pressure and room temperature (i.e. 25° C.), unless otherwise stated herein, or unless otherwise stated in the referenced test methods and procedures.

The following test methods were used to determine performance of the adjuvant compositions.
Rainfastness—A glass microscope slide was coated with a thin layer of PTFE sheet. To this a 5 μL droplet of the different formulations diluted at 1% in deionised water were applied with a micropipette and left to dry for 1-12 hours depending on the active ingredient. The slide was placed on a stage at 45° and each deposit was imaged using a handheld microscope and then subjected to a flow of deionised water using a peristaltic pump for a total of 5 minutes. A live image was recorded every 10 seconds during the washing process using the handheld microscope. The amount of active ingredient washed off was assessed using imaging software. Three-six replicates were measured, and the mean value of the replicates recorded, with results obtained in terms of percentage wash-off.
Molecular weight—This was determined using the GPC method with chromatograph Agilent 1260 Infinity/1290 Infinity II, column PL gel 5 μm mixed D, and a refractive index detector. A 1% w/v sample was made up in tetrahydrofuran solvent, and used in an injection volume of 50 μL, with flow rate 1 cm³ min 1 through the column which was at a temperature of 40° C. The analysis time was 30 minutes and area normalisation was used. A standard of polystyrene (Agilent EasiVial PS-M 2 ml GPC/SEC Calibration Standards; Mp range: 162 to 364,000 Da) was used.
Acid value-A 5 g sample of the alkyd resin was accurately weighed (to 0.1 mg) into a 250 cm³ flat-bottomed flask. 10 cm³ xylene and a quantity of anti-bumping granules were added and the flask heated until the xylene began to boil and the anti-bumping granules moved freely when the flask was swirled. A 50 cm³ portion of industrial denatured alcohol (IDA) was added and heated to brief reflux. 1 cm³ of 1% phenolphthalein in IDA was added and the acidity titrated with 0.5 M aqueous sodium hydroxide solution. The acid value was calculated as AV=56.105xt/w mg KOH g⁻¹, where x=molarity of NaOH, T=titre (cm³) and w=weight of alkyd resin (g).
Percentage solids—An Ohaus MB120 moisture analyser was used to assess the percentage solids. Samples were dried to a constant weight, allowing calculation of the percentage solids
Particle size values (PSD) D(v,0.9)—Particle size was analysed by dynamic light scattering using a Malvern Zetasizer using a particle refractive index of 1.56. Each sample was assessed and the average of 55 measurements recorded, with each measurement lasting 15 seconds.

The following materials were used in the examples:
“Soy fatty acid—8-12% C16:0, <6% C18:0, 20-35% C18:1, 45-60% C18:2, 2-10% C18:3” Rape top fatty acid-6.6% C16:0, 0.4% C16:1, 2.3% C18:0, 32.2% C18:1, 30% C18:2, 16.9% C18:3, 0.5% C20:0, 10.5% C20:1, 0.6% C20:2

With other polyols, fatty acids, and diacids as stated in the relevant tables.
Maxemul 7101—non-ionic surfactant-based O/W emulsifier and dispersant
Maxemul 7201—anionic oil soluble surfactant
Crodafos C10/5A—alkoxylated phosphate ester wetting agent and emulsifier
Synperonic PE/L 62—ethylene oxide/propylene oxide block copolymer surfactant
Tween 20—ethoxylated sorbitan monolaurate, nonionic surfactant
Span 20—sorbitan monolaurate low HLB surfactant
Synperonic PE/F 127—polyalkylene oxide block copolymer, water soluble surfactant and acts as a high HLB emulsifier
Atlas G-1086—sorbitol based non-ionic surfactant, polyoxyethylene (40) sorbitol hexaoleate

### Rainfastness Agents (Alkyd Resins) Formed

The following methods were used to synthesis a range of alkyd resins for rainfastness evaluation.
Method 1—Using xylene as water removal aid
A 5-necked flask equipped with a magnetic sealed stirrer guide with PTFE centrifugal stirrer, temperature feedback probe and isomantle, a nitrogen inlet and outlet via a Dean and Stark trap (pre-filled with xylene) with a Liebig condenser to an exit bubbler was charged with fatty acid, polyol and xylene (3 wt. %), and heated with stirring (350 rpm) under a flow of nitrogen (15 ml min⁻¹) to 220° C. until the quantity of water collected in the Dean and Stark trap was equal to the theoretical quantity calculated for an acid value of 15 mg KOH g⁻¹. The reaction mix was cooled to 170° C. and diacid added. The reaction was heated to 220° C. as before until the acid value had fallen to ca. 20 mg KOH g⁻¹. The reaction apparatus was re-configured for distillation and the xylene was removed. Vacuum was applied (<10 mbar) to continue the esterification reaction until an acid value of 10 (+2) mg KOH g⁻¹ was achieved. After cooling to below 100° C. the alkyd resin was obtained as a viscous yellow oil.
Method 1 used when the diacid was 6 carbons or less, i.e. for polymers P2, P3, P5, P6, P11, P12, P13, and P14.
Method 2—No xylene
A 5-necked flask equipped with a magnetic sealed stirrer guide with PTFE centrifugal stirrer, temperature feedback probe and isomantle, a nitrogen inlet and outlet via a distillation arm with a Liebig condenser and receiver flask to an exit bubbler was charged with fatty acid, polyol and diacid. The reaction mix was heated to 190° C. for 1 hour and the temperature was increased to 220° C. for a further 1 hour. The distillation arm was replaced with a simple pot-to-pot distillation tube and vacuum applied to 200 mbar and the reaction allow to continue until an acid value of 10±2 mg KOH g⁻¹ was achieved. The alkyd resin was obtained as a viscous yellow oil.
Method 2 used when the diacid is greater than 6 carbons, i.e. for polymers P1, P4, P7, P8, P9, P10, and P15.

The following polymers in Table 1 were formed using the methods described herein.

TABLE 1
Alkyd resins formed

| Alkyd | | | |
|---|---|---|---|
| resin | Fatty acid | Polyol | Diacid |
| P1 | Rape top fatty acid | Glycerol | Azelaic acid |
| P2 | Isostearic acid | Glycerol | Adipic acid |
| P3 | Soy fatty acid | Glycerol | Succinic acid |
| P4 | Soy fatty acid | Pentaerythritol | Azelaic acid |
| P5 | Soy fatty acid | Trimethylolpropane | Adipic acid |
| P6 | Isostearic acid | Glycerol | Adipic acid |
| P7 | Stearic/isostearic | Glycerol | Azelaic acid |
| | acid blend | | |
| P8 | Stearic/isostearic | Diglycerol | Azelaic acid |
| | acid blend | | |
| P9 | Soy fatty acid | Diglycerol | Sebacic acid |
| P10 | Soy fatty acid | Pentaerythritol | Sebacic acid |
| P11 | Lauric acid | Glycerol | Adipic acid |
| P12 | Soy fatty acid | Pentaerythritol | Succinic |
| | | | anhydride |
| P13 | Stearic acid | Glycerol | Adipic acid |
| P14 | Caprylic acid | Pentaerythritol | Adipic acid |
| P15 | Soy/stearic | Glycerol | Azelaic acid |
| | acid blend | | |

Polymers P2 and P6 were made with different grades of isostearic acid: isostearic acid for P2 (and P7 and P8) includes 36% mono-methyl branched and 45% multi-carbon branching; isostearic acid for P6 includes 71% mono-methyl branching and 6% multi-carbon branching.

The acid values and molecular weights of the synthesised alkyd resin polymers were then determined using the methods described herein, with results shown in Table 2.

TABLE 2
Acid values and molecular weights

| Alkyd resin | Acid | MW of |
|---|---|---|
| polymer | Value | polymer |
| P1 | 7.2 | 22,000 |
| P2 | 11.8 | 39,300 |
| P3 | 10.0 | 3,500 |
| P4 | 10.0 | 53,200 |
| P5 | 10.7 | 10,300 |
| P6 | 9.2 | 18,300 |
| P7 | 10.1 | 14,400 |
| P8 | 11.2 | 41,400 |
| P9 | 11.6 | 137,100 |
| P10 | 8.6 | 208,100 |
| P11 | 11.2 | 59,800 |
| P12 | 9.8 | 12,200 |
| P13 | 10.0 | 22,100 |
| P14 | 8.6 | 52,400 |
| P15 | 12.2 | 14,400 |

### Emulsions Formed

The alkyd resin polymers were then used to form a number of emulsion systems. The emulsion systems formed are shown in Table 3.

The emulsion systems were formed using the following method:
A cylindrical (flat bottomed) glass vessel with a full surrounding jacket for a heating fluid, equipped with an Intermig impeller (EKATO) having a diameter only slightly less than the vessel was charged with the alkyd resin (200 g). The circulator fluid temperature was set to 75° C. and the stirring rate to 50 rpm.
A quantity of water calculated to give the required final weight for the emulsion was charged to a flat-bottomed flask and placed on a hotplate set to the emulsification temperature to pre-heat the water for emulsification. Once the set temperature was reached a quantity of KOH calculated to neutralise 40% of the acid value of the alkyd resin was added to the emulsification vessel and the stirring rate increased to 100 rpm. After 30 min, the emulsifiers were added to the vessel (3% each on alkyd weight) and the stirrer speed increased to 175 rpm. After an additional 30 min, the circulator fluid temperature was decreased to the emulsification temperature for the particular alkyd resin (determined by alkyd viscosity).
Addition of the water for emulsification was begun by peristaltic pump pre-calibrated to an addition rate of 0.4 cm³ min⁻¹; inversion of the emulsion phase from W/O to O/W occurred after approximately ½ of the total volume of water had been added, after which the water addition rate was increases incrementally to 1.6 cm³ min⁻¹ until addition was complete.

TABLE 3
alkyd resin emulsion systems

| Alkyd | | | | PSD | Solids |
|---|---|---|---|---|---|
| resin | Emulsion | Emulsifier 1 | Emulsifier 2 | (nm) | (%) |
| P1 | E1 | Maxemul 7101 | Maxemul 7201 | 1212 | 51.7 |
| P2 | E2 | Maxemul 7101 | Maxemul 7201 | 1103 | 51.8 |
| P3 | E3 | Maxemul 7101 | Maxemul 7201 | 283.8 | 51.4 |
| P2 | E4 | Maxemul 7101 | Crodafos | 2900 | 53.5 |
| | | | C10/5A | | |
| P4 | E5 | Maxemul 7101 | Maxemul 7201 | 1173 | 51.0 |
| P2 | E6 | Synperonic | Maxemul 7201 | 2780 | 53.1 |
| | | PE/L 62 | | | |
| P5 | E7 | Maxemul 7101 | Maxemul 7201 | 1106 | 51.4 |
| P2 | E8 | Tween 20 | Span 20 | 1470 | 50.7 |
| P6 | E9 | Maxemul 7101 | Maxemul 7201 | 235.7 | 51.1 |
| P7 | E10 | Maxemul 7101 | Maxemul 7201 | 220.4 | 49.3 |
| P2 | E11 | Synperonic | Maxemul 7201 | 1780 | 51.5 |
| | | PE/F 127 | | | |
| P8 | E12 | Maxemul 7101 | Maxemul 7201 | 307.7 | 51.1 |
| P9 | E13 | Maxemul 7101 | Maxemul 7201 | 244.3 | 51.8 |
| P2 | E14 | Atlas G-1086 | Maxemul 7201 | 1320 | 50.9 |
| P10 | E15 | Maxemul 7101 | Maxemul 7201 | 586.1 | 51.2 |

The emulsifier ratio was 1:1, apart from emulsion E8 where the ratio of Emulsifier 1 to Emulsifier 2 was 3:1 respectively. The results for PSD and solid content demonstrate that a stable emulsion was formed.

### Formulations Formed

The active ingredient, dispersant, wetting agent and other formulants were mixed using high shear homogenisation to form a slurry, then passed through a bead mill to achieve a particle size D (0.9) between 1-10 microns. The rheological modifier and antifreeze were then added with a portion of the water phase and combined using high shear homogenisation to form the formulation. Formulations were prepared with the following recipes as shown in Table 4 and 5.

TABLE 4
Azoxystrobin based formulation

| Component | % w/w |
|---|---|
| Azoxystrobin | 23.98 |
| Dispersant | 1.16 |
| Wetting agent | 1.55 |
| Antifoam | 0.09 |
| Biocide | 0.19 |
| Antifreeze | 5.83 |
| Rheological modifier | 0.3 |
| Rainfastness agent | 3.0 |
| Water | 63.90 |

TABLE 5
Imidacloprid based formulation

| Component | % w/w |
|---|---|
| Imidacloprid | 43.66 |
| Dispersant | 1.28 |
| Wetting agent | 0.42 |
| Antifoam | 0.08 |
| Biocide | 0.08 |
| Antifreeze | 4.23 |
| Rheological modifier | 0.1 |
| Rainfastness agent | 3.0 |
| Water | 47.15 |

The active formulations were then combined in to the emulsions of Table 3, and subjected to evaluation for rainfastness using the method noted herein.

TABLE 6
Rainfastness performance results using
Azoxystrobin based formulation

| Emulsion | % Wash off |
|---|---|
| No additive | 93.0 |
| E1 | 55.4 |
| E2 | 57.3 |
| E3 | 60.8 |
| E5 | 53.2 |
| E7 | 52.2 |
| E9 | 42.6 |
| E10 | 57.2 |
| E12 | 48.4 |
| E13 | 47.6 |
| E15 | 45.0 |

TABLE 7
Rainfastness performance results using
Imidacloprid based formulation

| Emulsion | % Wash off |
|---|---|
| No additive | 80.9 |
| E2 | 61.5 |
| E5 | 36.3 |
| E9 | 47.8 |
| E10 | 33.1 |
| E12 | 59.0 |
| E15 | 15.7 |

For both Azoxystrobin and Imidacloprid formulations the percentage wash-off was significantly reduced when compared to formulations not comprising the alkyd resin rainfastness agent. The alkyd resin rainfastness agent provided for good rainfastness of the active.

It is to be understood that the invention is not to be limited to the details of the above embodiments, which are described by way of example only. Many variations are possible.

1. An agrochemical formulation comprising;
i) a rainfastness agent selected from an alkyd resin formed from C2 to C16 diacids, C6 to C30 fatty acids, and C3 to C8 polyols; and
ii) at least one selected from an agrochemical active, nutrient, or biostimulant.

2. The agrochemical formulation according to claim 1, wherein the polyol is selected from glycerol, diglycerol, triglycerol, tetraglycerol, trimethylolpropane, trimethylolpropane, isosorbide, or pentaerythritol.

3. The agrochemical formulation according to claim 2, wherein the polyol is selected from glycerol, diglycerol, trimethylolpropane, or pentaerythritol.

4. The agrochemical formulation according to claim 1, wherein the polyol is a sugar alcohol selected from glucose, fructose, sorbitol, sorbitan, xylitol, threitol, ribitol, fucitol, mannitol, sucrose, galactitol, iditol, inositol, or volemitol.

5. The agrochemical according to claim 1, wherein the diacid is a linear C4 to C10 diacid.

6. The agrochemical according to claim 5, wherein the diacid is selected from succinic acid, glutaric acid, adipic acid, pimelic acid, suberic acid, azelaic acid, sebacic acid, and undecanedioic acid.

7. The agrochemical formulation according to claim 1, wherein the fatty acids are C8 to C30 fatty acids.

8. The agrochemical formulation according to claim 7, wherein the fatty acids are selected from isostearic, stearic, isostearic, caprylic, lauric, and mixtures thereof.

9. The agrochemical formulation according to claim 1, wherein the alkyd resin is formed from a combination of: glycerol-azelaic acid-rapeseed oil, glycerol-isostearic acid-adipic acid, glycerol-succinic acid-soybean oil, pentaerythritol-azelaic acid-soybean oil, trimethylolpropane-adipic acid-soybean oil, glycerol-adipic acid-isostearic acid, glycerol-azelaic acid-stearic/isostearic acid blend, diglycerol-azelaic acid-stearic/isostearic acid blend, diglycerol-sebacic acid-soybean oil, pentaerythritol-sebacic acid-soybean oil, glycerol-adipic acid-lauric acid, pentaerythritol-succinic anhydride-soybean oil, glycerol-adipic acid-adipic acid-stearic acid, pentaerythritol-adipic acid-caprylic acid, and glycerol-azelaic acid-soybean oil and stearic acid blend.

10. The agrochemical formulation according to claim 1, wherein the molecular weight of the alkyd resin is from 3,000 to 220,000 Da.

11. The agrochemical formulation according to claim 1, wherein the amount of polyols present in the alkyd resin is in the range from 5 to 45 wt. % as a percentage of the total copolymer weight.

12. The agrochemical formulation according to claim 1, wherein the amount of diacid present in the alkyd resin is in the range from 2 to 60 wt. % as a percentage of the total copolymer weight.

13. The agrochemical formulation according to claim 1, wherein the amount of fatty acids present in the alkyd resin is in the range from 20 to 85 wt. % as a percentage of the total copolymer weight.

14. The agrochemical formulation according to claim 1, wherein the molar ratio of the fatty acid to polyol to diacid is in the range 1:0.35-0.60:0.60-0.95.

15. The agrochemical formulation according to claim 1, wherein the alkyd resin is in an emulsified form or an emulsification system

16. A concentrate formulation suitable for making an agrochemical formulation in accordance with claim 1, the concentrate comprising;
i) a rainfastness agent selected from an alkyd resin formed from C2 to C16 diacids, C6 to C30 fatty acids, and C3 to C8 polyols; and
ii) at least one selected from an agrochemical active, nutrient, or biostimulant dispersed in a water medium.

17. The concentrate formulation according to claim 16, wherein the formulation is an suspension concentrate.

18. Use of a rainfastness agent selected from an alkyd resin in accordance with claim 1, as part of a foliar application for improving the rainfastness of an agrochemical active ingredient, nutrient, or biostimulant.

19. A method of treating vegetation to control pests, the method comprising applying agrochemical formulation in accordance with claim 1, either to the vegetation or to the immediate environment of the vegetation.

20. An emulsified formulation comprising a rainfastness agent selected from an alkyd resin formed from C2 to C16 diacids, C6 to C30 fatty acids, and C3 to C8 polyols, suitable for foliar application.
